(19) United States
(12) Patent Application Publication
(10) Pub. No.: US 2007/0283961 A1
(43) Pub. Date: Dec. 13, 2007

(54) Air purifier for a protective garment

(76) Inventor: Hsin-Mao Hsieh, Ping Tung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/448,083

(22) Filed: Jun. 7, 2006

(51) Int. Cl. A62B 23/02

(52) U.S. Cl. 128/205.29; 128/205.27

(57) ABSTRACT

An air purifier for a protective garment is connected to the protective garment with a air duct and has a housing having an inlet and an outlet, a filter attached to the inlet, a fan mounted in the housing adjacent to the filter, a thermal conductor mounted between the fan and the outlet, a thermoelectric cooling module attached to the thermal conductor and a power supply mounted in the housing and connected electrically to the fan and the thermoelectric cooling module. When the fan rotates, air outside the housing is filtered by the filter and drawn into the housing, appropriately warmed up or cooled down by the thermal conductor and flows into the protective garment. The air purifier provides clean air for a user wearing the protective garment at room temperature.

### BACKGROUND OF THE INVENTION

1. Field of the Invention

The present invention relates to an air purifier for a protective garment, and more particularly to an air purifier with an air conditioning utility.

2. Description of the Related Art

To avoid infecting with viruses, microbes or poisonous chemicals, people wear protective garments to act in a biological polluted or a chemical polluted environment. To keep people breathing when they wear the airtight protective garments, the protective garment is equipped with an air purifier to purify air to provide clean air for a user wearing the protective garment on, and to protect the user from inhaling poisonous gas.

The protective garment has an exhaling channel, an air intake, an air duct and a belt and may be a protective suit or a protective helmet. The exhaling channel is one-way and only for exhaling air from the protective garment. The air duck is connected to the air intake of the protective garment.

A conventional air purifier in accordance with the prior art is connected to the protective garment with the air duct and comprises a housing, a filter, a fan and a power supply.

The housing is airtight, is attached on the belt to be carried by the user wearing the protective garment and has an inlet and an outlet to allow air flowing through. The outlet of the housing is connected to the air intake of the protective garment with the air duct to allow air to flow into the protective garment.

The filter is attached to the inlet of the housing to purify air flowing through the inlet of the housing.

The fan is mounted in the housing between the filter and the outlet of the housing to draw air outside the housing to get through the filer and flow into the housing.

The power supply is mounted in the housing and connected electrically to the fan to provide electric power for the fan.

The conventional air purifier can provide clean air for the user when the fan operates. However, the protective garment is airtight and heat generating by the body temperature of the user is hard to remove from the protective garment. Thus, the user feels hot and uncomfortable and can not work well.

### SUMMARY OF THE INVENTION

The primary objective of the present invention is to provide an air purifier for a protective garment to provide clean air of normal temperature for a user wearing the protective garment.

The air purifier in accordance with the present invention is connected to the protective garment with an air duct and has a housing, a filter, a fan, a thermal conductor, a thermoelectric cooling module and a power supply.

The housing has an inlet and an outlet connected to the protective garment with the air duct to allow air to flow into the protective garment.

The filter is attached to the inlet of the housing to filter off microbes or poisonous chemicals in air.

The fan is mounted in the housing adjacent to the filter to draw air into the housing when rotating.

The thermal conductor is mounted between the fan and the outlet of the housing to provide a heat exchanging effect to the air flowing through the thermal conductor.

The thermoelectric cooling module is attached to the thermal conductor to selectively warm up or cool down the thermal conductor.

The power supply is mounted in the housing and is connected electrically to the fan and the thermoelectric cooling module to supply electrical power to the fan and the thermoelectric cooling module.

Other objectives, advantages and novel features of the invention will become more apparent from the following detailed description when taken in conjunction with the accompanying drawings.

### BRIEF DESCRIPTION OF THE DRAWINGS

FIG. 1 is a top view in partial section of a preferred embodiment of an air purifier in accordance with the present invention;

FIG. 2 is a perspective view of the air purifier in FIG. 1, wherein the air purifier is connected to a protective helmet;

FIG. 3 is an operational front view of the air purifier in FIG. 1, wherein the air purifier is connected to a protective suit; and

FIG. 4 is an operational top view in partial section of the air purifier in FIG. 1.

### DETAILED DESCRIPTION OF THE PREFERRED EMBODIMENT

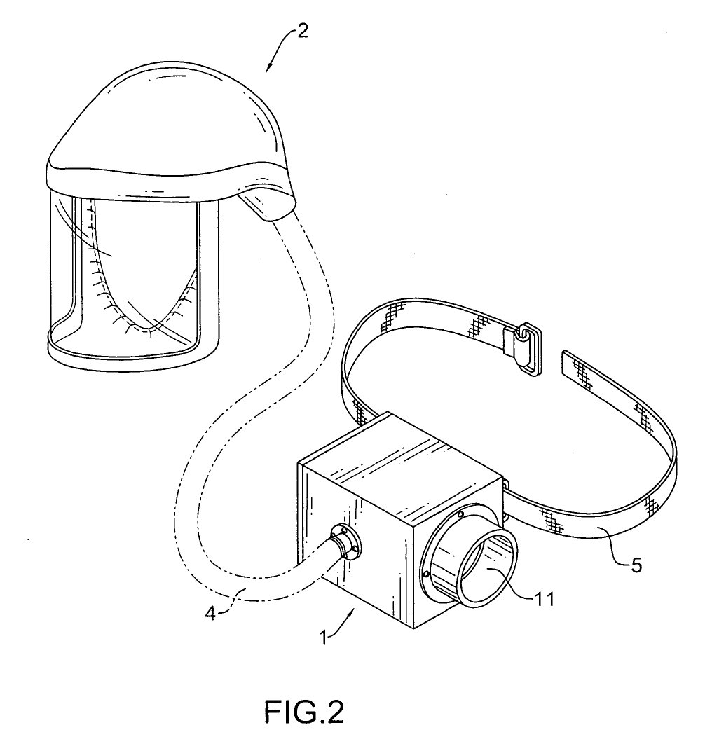

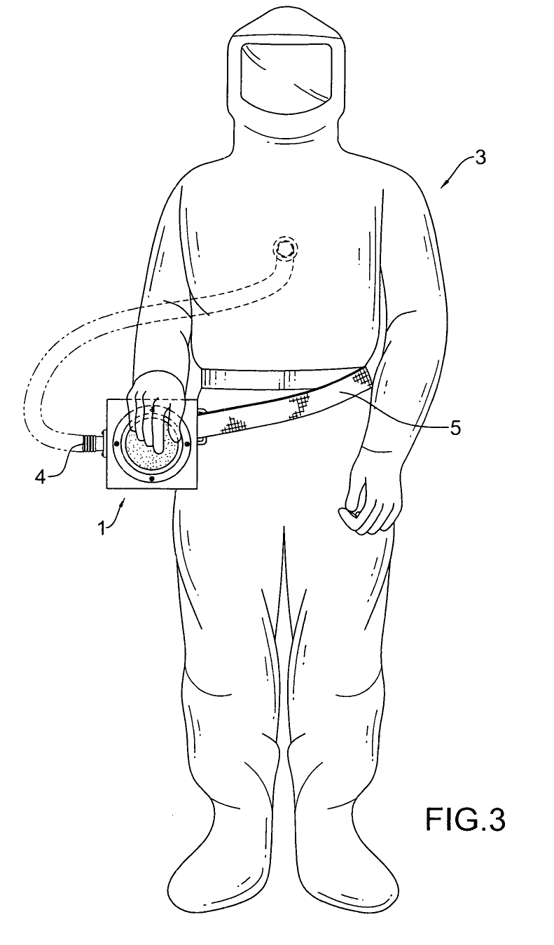

With reference to FIGS. 2 and 3, a protective garment (2, 3) has an exhaling channel, an air intake, an air duct (4) and a belt (5) and may be a protective helmet (2) or a protective suit (3). The exhaling channel is one-way and only for exhaling air from the protective garment (2, 3). The air duct (4) is connected to the air intake of the protective garment (2, 3) and an air purifier (1) in accordance with the present invention.

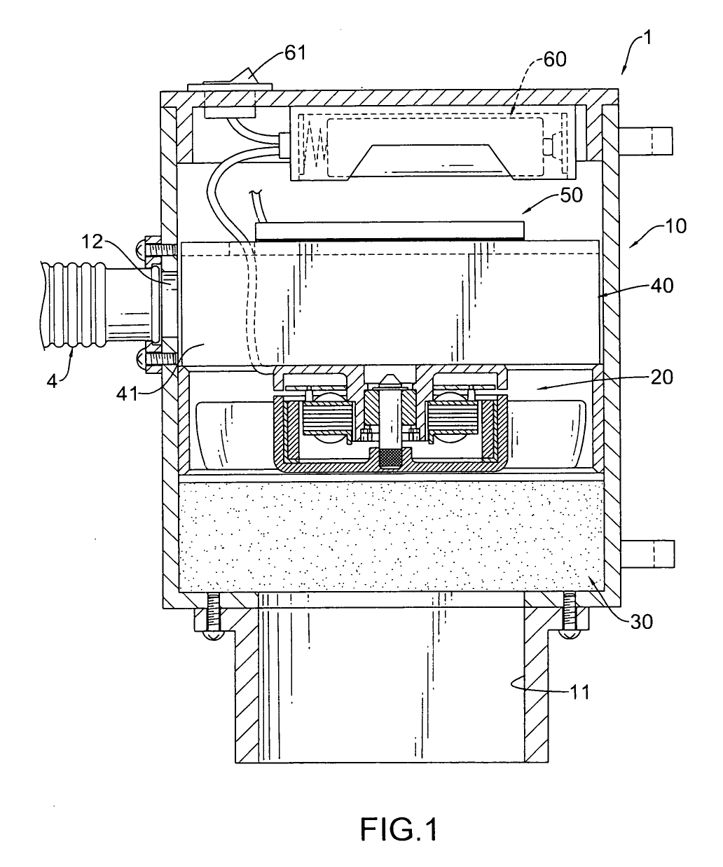

With reference to FIGS. 1, the air purifier (1) is connected to the protective garment (2, 3) with the air duct (4) and comprises a housing (10), a filter (30), a fan (20), a thermal conductor (40), a thermoelectric cooling module (50) and a power supply (60).

The housing (10) is airtight, is attached on the belt (5) to allow the air purifier (1) to be carried by the user wearing the protective garment (2, 3) and has an inlet (11) and an outlet (12) to allow air to flow through. The outlet (12) of the housing (10) is connected to the air intake of the protective garment (2, 3) with the air duct (4) to make air flow into the protective garment (2, 3) via the air duct (4).

The filter (30) is attached to the inlet (11) of the housing (10) to purify air flowing into the housing (10) via the inlet (11) of the housing (10) and may be a biological filter to filter microbes off, a chemical filter to filter poisonous chemicals off or an N95 filter to filter viruses.

The fan (20) is mounted between the inlet (11) and the outlet (12) of the housing (10) adjacent to the filter (30) to draw air outside the housing (10) to get through the filter (30) and flow into the housing (10) when the fan (20) rotates.

The thermal conductor (40) is mounted between the fan (20) and the outlet (12) of the housing (10), has a thermal conductivity and may has multiple fins (41) to increase area for heat conduction to improve the efficiency of heat exchanging when air flows through the fins (41).

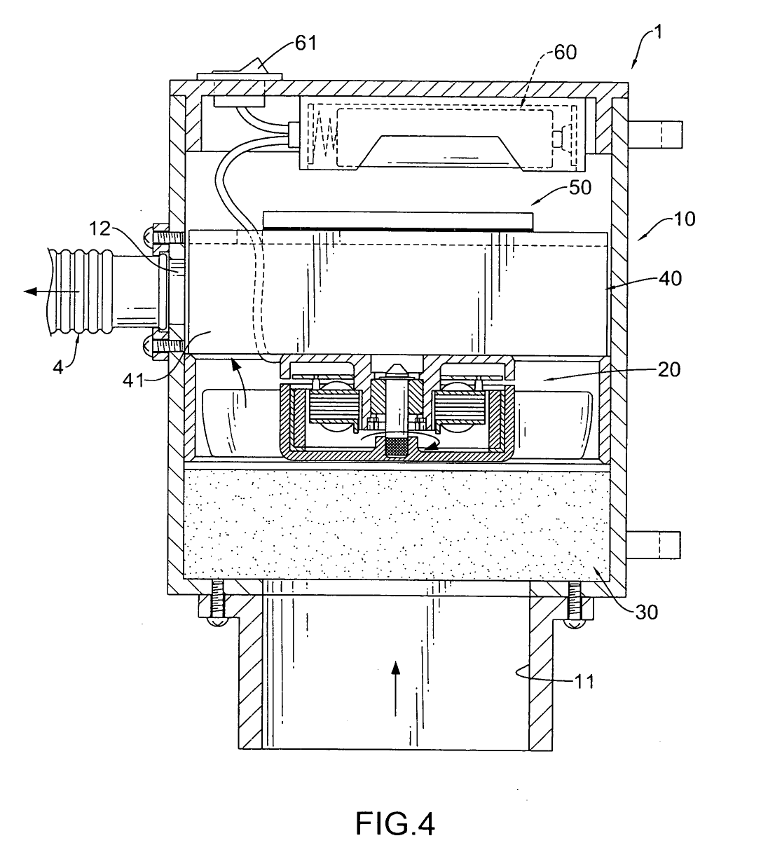

The thermoelectric cooling module (50) is attached to the thermal conductor (40) and has a hot surface and a cold surface. When the thermoelectric cooling module (50) is electrified, the hot surface is warmed up and the cold surface is cooled down. With further reference to FIG. 4, one of the hot surface and the cold surface of the thermoelectric cooling module (50) can be chosen to attach to the thermal conductor (40) according to a temperature of operating environment. Accordingly, the air flowing through the fins (41) of the thermal conductor (40) is appropriate warmed or cooled and flows into the protective garment (2, 3) to adjust the temperature in the protective garment (2, 3).

The power supply (60) is mounted in the housing (10), is connected electrically to the fan (20) and the thermoelectric cooling module (50) and has a battery and a switch (61). The battery is electrically connected to and supplies electric power to the fan (20) and the thermoelectric cooling module (50) and may be a dry battery, a rechargeable battery or other types of batteries. The switch (61) is connected electrically to the fan (20) and the thermoelectric cooling module (50) and is used to switch on or off the fan (20) and the thermoelectric cooling module (50).

The air filter (1) in accordance with the present invention provides clean air at room temperature to the user wearing the protective garment (2, 3). Further, the clean air at the room temperature adjusts the temperature in the protective garment (2, 3) to make the user work in a comfortable temperature such that the work efficiency of the user is improved.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. An air purifier for a protective garment comprising:
a housing being airtight and having an inlet and an outlet;
a filter attached to the inlet of the housing;
a fan mounted between the inlet and the outlet of the housing adjacent to the filter;
a thermal conductor mounted between the fan and the outlet of the housing;
a thermoelectric cooling module attached to the thermal conductor and having a hot surface and a cold surface; and
a power supply mounted in the housing, connected electrically to the fan and the thermoelectric cooling module and having
a battery electrically connected to the fan and the
thermoelectric cooling module to supply electrical power to the fan and the thermoelectric cooling module; and
a switch connected electrically to the fan and the thermoelectric cooling module.

2. The air purifier as claimed in claim 1, wherein the filter is a chemical filter.

3. The air purifier as claimed in claim 1, wherein the filter is a biological filter.

4. The air purifier as claimed in claim 1, wherein the thermal conductor has multiple fins.

5. The air purifier as claimed in claim 1, wherein the hot surface of the thermoelectric cooling module is attached to the thermal conductor.

6. The air purifier as claimed in claim 1, wherein the cold surface of the thermoelectric cooling module is attached to the thermal conductor.

7. The air purifier as claimed in claim 1, wherein the battery of the power supply is a rechargeable battery.
